(19) United States
(12) Patent Application Publication
(10) Pub. No.: US 2015/0006060 A1
(43) Pub. Date: Jan. 1, 2015

(54) SYSTEM AND METHOD FOR CONTROLLING ENGINE FUEL CUT

(71) Applicant: Toyota Motor Engineering & Manufacturing North America, Inc., Erlanger, KY (US)

(72) Inventor: Tai J. Ly, Los Angeles, CA (US)

(21) Appl. No.: 13/929,079

(22) Filed: Jun. 27, 2013

(51) Int. Cl. F02D 41/30

(52) U.S. Cl. CPC F02D 41/3005
USPC 701/104

(57) ABSTRACT

A system including a sensor, data storage unit to store data relating to the positioning of the accelerator pedal, a processor connected to determine if the data relating to the accelerator pedal reaches a predetermined level. If the data reaches the predetermined level, a controller sends a signal to the fuel injector requiring the fuel injector to cut the fuel to the engine. A method of the present invention including sensing by a sensor to determine the positioning of an accelerator pedal, storing data relating to the positioning of the accelerator pedal in a data storage unit, determining by a processor if the data relating to the positioning of the accelerator pedal is above a predetermined level, and sending a signal by a controller to the fuel injector to stop fuel flow if the data relating to the positioning of the accelerator pedal is above the predetermined level.

### FIELD OF THE INVENTION

The present invention relates generally to a vehicle control device and method. More particularly, the present invention relates to a vehicle control device for controlling fuel cut.

### BACKGROUND OF THE INVENTION

Fuel cut relates to cutting the fuel supply to the engine, specifically a fuel injector. Current vehicles and vehicle control systems require a fuel cut when the accelerator pedal is at 0%, or when the user is no longer depressing the accelerator pedal. Prior systems for cutting fuel are operable to cut the fuel based on the vehicle speed and the driver release of the pedal. These present concepts cut the fuel when the accelerator is no longer pressed. This method creates a large delay and wasted fuel from the time the user stops depressing the pedal until the time when the fuel is actually cut. This delay in time creates wasted fuel and creates a lower fuel economy for the vehicle.

Accordingly, there exists a need in the art to provide a system and method for providing a fuel cut to an engine. Further, there exists a need to provide a fuel cut to an engine for which timing to complete the fuel cut is decreased to reduce fuel consumption.

### SUMMARY OF THE INVENTION

The present system provides for controlling a fuel injector for a vehicle. The system includes a sensor for measuring the positioning of an accelerator pedal. The accelerator produces data relating to positioning of the accelerator pedal. The system further includes a data storage unit connected to the sensor to store the data relating to the positioning of the accelerator pedal. A processor is further provided connected to the data storage unit to determine if the data relating to the accelerator pedal reaches a predetermined level.

A controller is provided to receive a signal from the processor if the data relating to the accelerator pedal reaches the predetermined level. If the data reaches the predetermined level, the controller sends a signal to the fuel injector requiring the fuel injector to cut the fuel to the engine.

A method of the present invention includes sensing by an accelerator pedal sensor to sense the positioning of an accelerator pedal, storing data relating to the positioning of the accelerator pedal in a data storage unit, determining by a processor if the data relating to the positioning of the accelerator pedal is above a predetermined level, and sending a signal by a controller to the fuel injector to stop fuel flow if the data relating to the positioning of the accelerator pedal is above the predetermined level. The predetermined level for both the system and method examines the pedal position and the pedal rate of change of positioning to determine the predetermined level. Fuel cut will be performed when the accelerator's rate of change is negative and the accelerator's position meets a certain condition (near 0%). The controller will activate the fuel cut when the driver is still releasing the accelerator at a minimum rate and the accelerator reaches a certain position of greater than 0%. This system and method decreases the time for which a signal is sent to the controller to cut the fuel of the fuel injector. As such, the fuel cut is quicker and more fuel is saved.

### BRIEF DESCRIPTION OF THE DRAWINGS

FIG. 1 is a graphical representation of the angle of the accelerator position, the accelerator rate of change, the air-fuel ratio, and timing of the fuel cut signal;

FIG. 2 illustrates the system of the present invention;

FIG. 3 illustrates an alternative embodiment of the system of the present invention;

FIG. 4 illustrates yet another alternative embodiment of the present invention; and

FIG. 5 illustrates the method of the present invention.

### DETAILED DESCRIPTION OF THE PREFERRED EMBODIMENTS

The present system and method reduce timing to activate the fuel cut of a vehicle engine. The system and method look to both the accelerator position (or the angle of rotation) and the rate of change of position of the accelerator pedal. The system and method utilize a processor and a controller to determine if the accelerator position and the accelerator rate of change meet a predetermined level. If the data acquired from the sensor measuring the accelerator position and the accelerator rate of change detects and the processor determines that the data meets the predetermined level, a controller sends a signal to the fuel injector to cut the fuel. This system and method for fuel cut decreases the amount of time between the user ceasing to depress the pedal and the actual fuel cut time. This in turn dramatically improves fuel economy of the vehicle.

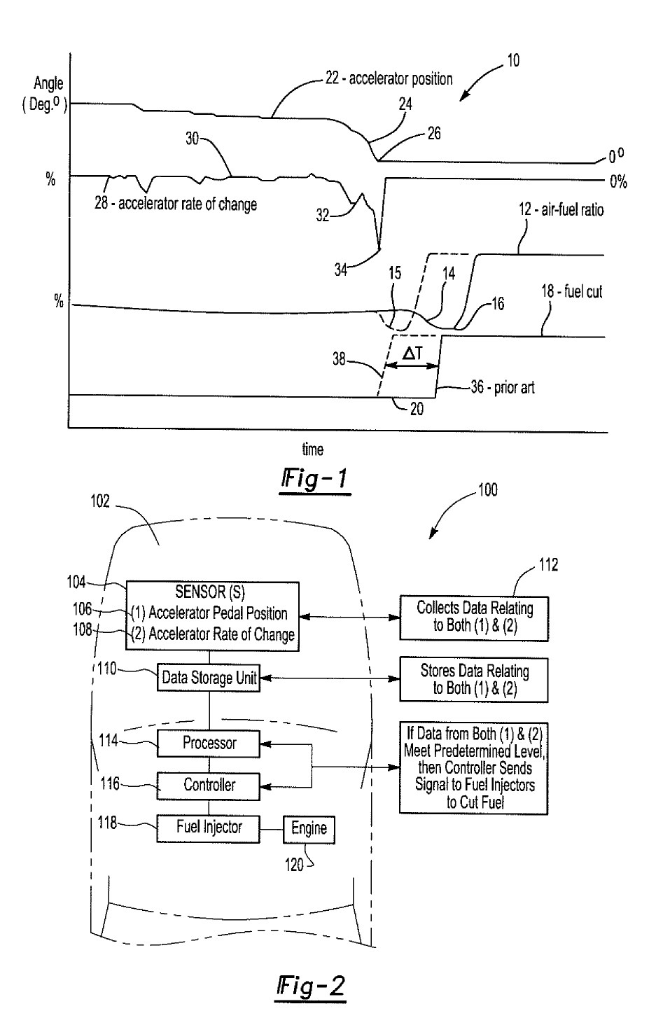

FIG. 1 is a graphical representation of various measurements taken from a control system. The graph 10 illustrates a graphical representation of the air-fuel sensor ratio 12. The air-fuel sensor ratio 12 illustrates a relatively smooth curve of the percentage with respect to a time delay. Previous controllers for controlling the fuel cut of an engine look to the air-fuel sensor and air-fuel ratio as a result and measure of the fuel cut as depicted by the line 12. As the user ceases to depress the pedal, the graphical representation as shown by reference numeral 14 depicts a drop and then a dramatic rise in the graph of the air-fuel sensor ratio. The dashed line 15 represents the improved timing of the air fuel ratio as compared to the prior art. The dashed line 15 represents the air fuel ratio reaching a 0 level at a time much before the prior art.

As the graph levels out, this illustrates that the air-fuel ratio is high. Once the graph starts to drop near reference numeral 14, a signal is sent to the controller to cut the fuel. This signal is graphically illustrated by the fuel cut flag/signal 16. As the air-fuel ratio begins to drop at reference numeral 14, a signal is sent to the fuel injector to cut the fuel. This fuel cut signal is shown at portion 18 in the graphical representation. Portion 20 of the graph illustrates the time period before the signal is sent. Portion 20 illustrates an overlap in time of the time between when the user completely ceases or starts to cease depression of the accelerator pedal. This comparison is further illustrated by the accelerator position 22 and the accelerator rate of change 28 shown at the top of the graph.

Accelerator position 22 is illustrated as an angle of rotation measured in degrees with respect to time. The accelerator position 22 illustrates a decrease in the angle at reference numeral 24. Reference numeral 26 illustrates the point where the user has completely ceased depressing the accelerator pedal. The accelerator rate of change 28 is shown by graphically comparing the percentage of the rate of change with respect to the time.

The accelerator rate of change 28 is graphically represented at 30 illustrating a plurality of peaks and valleys in the accelerator rate of change as the user changes his or her depression of the accelerator pedal. Point 32 of the graph 30 illustrates a drop in the accelerator rate of change along with reference numeral 34 where the driver releases the accelerator pedal. This point 34 where the driver releases the accelerator pedal and portion 26 of the accelerator position 22 graph are used to determine when a signal should be sent to the fuel injector by a controller. This data is collected and stored by means of a data storage unit and is processed by a processor to determine when the fuel should be cut. If it is determined that the accelerator rate of change meets a certain percentage and that the accelerator position meets a certain angle of displacement, so that it is determined that the user is rapidly decelerating and removing his or her foot from the accelerator pedal, then a controller will send a signal to the fuel injector at a position 38 to more quickly activate the fuel cut.

The prior art illustrates the signal 36 at a particular time sent to the engine of the vehicle. As compared to the signal 38 when the accelerator position 22 and the accelerator rate of change 28 are used to determine appropriate time for fuel cut, the signal 38 is sent much faster than signal 36 when taking into account the air-fuel ratio. Δt represents the time period savings to reach the fuel cut when using the signal 38. The Δt using signal 38 can save as much as 1 to 2 seconds thus dramatically decreasing fuel consumption.

FIG. 2 illustrates the system 100 of the present invention. The system 100 includes a vehicle 102 having a sensor or sensors 104. The sensors included are the accelerator pedal position sensor 106 and the accelerator rate of change 108. The sensors 106, 108 may be included into one sensor 104 capable of acquiring all data required to determine when fuel cut is appropriate. The sensor(s) 104, 106, 108 collect data 112 relating to the accelerator pedal position and the accelerator rate of change. The data 112 relating to the accelerator pedal position is data relating to the angle of rotation or degree of displacement with respect to a control plane of the accelerator pedal.

The accelerator pedal position is measured in terms of degrees. The data 112 also relates to the accelerator rate of change. The accelerator rate of change data measures the accelerator pedal position with respect to time. The accelerator rate of change may be determined in ratio or percentage form. The data 112 is then stored in a data storage unit 110. The data storage unit 110 stores data relating to both the accelerator pedal position and the accelerator rate of change. The data storage unit then sends the data 112 to a processor 114. The processor 114 determines if fuel cut is appropriate.

The processor 114 determines if data from both the accelerator pedal position and the accelerator rate of change meets the predetermined level. If the data from the accelerator pedal position and the accelerator rate of change meets the predetermined level, then the controller 116 sends a signal to the fuel injector 118 to cut the fuel. The fuel injector 118 is connected to an engine 120. In the present invention, the processor is a computer capable of making determinations if the data read from the sensor meets a predetermined level. The processor looks to a set of data or a data point and electronically compares the set of data or the data point to the predetermined level. A lookup table may also be used by the processor to determine if the data meets the predetermined level. If the processor determines that the set of data or the data point meets the predetermined level, the processor accordingly determines that vehicle is on a winding road. In other words, if the set of data or the data point meets the predetermined level, then the processor automatically determines that a signal should be sent to the controller for fuel cut.

The processor was also looks to multiple sets of data or data points from different sensors. If the vehicle has 2 sensors (either measuring the same thing or different measurements), the vehicle collects data from both sensors. Both data sets are sent to the processor for the processor to determine if the data sets each meet their respective predetermined levels. In one embodiment, if at least one data set meets the predetermined level, then the processor determines that the vehicle is on a winding road. Priority may be given to specific sensors.

The processor 114 is operable to compare a data set from a sensor to a predetermined level. The processor 114 functions so as to take a first set of data (or a data point) and compare it with a predetermined level (or predetermined range of levels or predetermined data). The predetermined levels may be stored for comparison by the processor in a look-up table. If the processor determines a match between the predetermined level and the data set, then the processor determines and reaches the conclusion that the vehicle is on a winding road. When the processor makes the determination that fuel cut is required, then the processor communicates with the controller of the fuel injector to engage fuel cut.

The data storage unit 110 of the present invention is a computer operable to store the data 112. The processor 114 is also a computer operable to process formulas and compare the data 112 to the predetermined levels.

The predetermined level for the accelerator pedal position ranges between 0° and 30° of angle displacement of the pedal. The pedal position may also be measured as a percentage. The accelerator rate of change predetermined level ranges between 0% and 30% rate of change. The accelerator rate of change relates to the accelerator pedal position with respect to time.

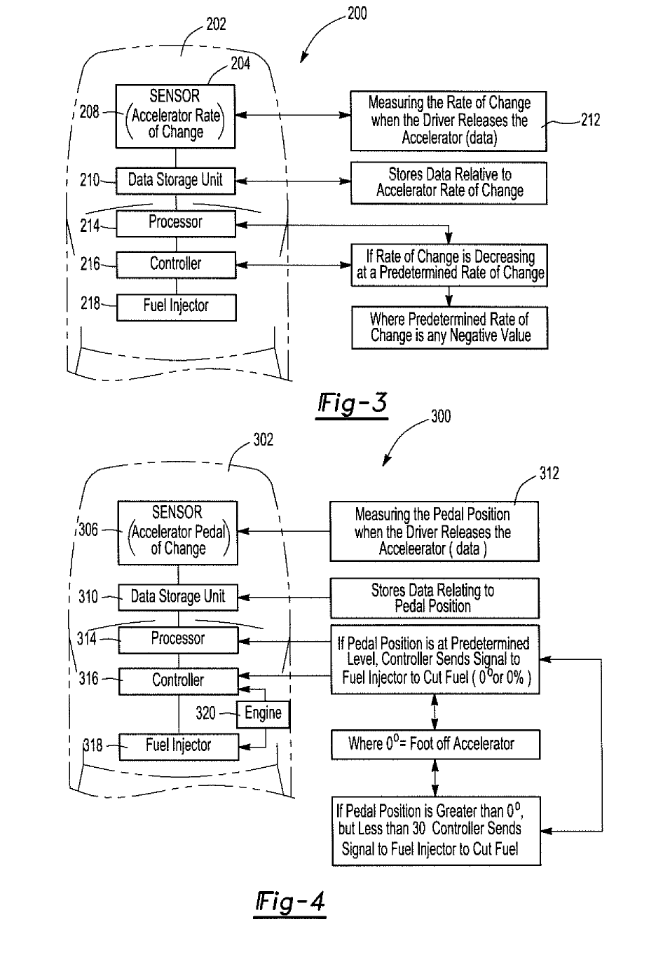

FIG. 3 illustrates an alternative embodiment system 200 of the present invention. The system 200 includes a vehicle 202 having a sensor 204. The sensor 204 strictly measures the accelerator rate of change in terms of a percentage or ratio of the accelerator pedal position with respect to time. The sensor 204 measures the rate of change when the driver releases the accelerator. The sensor 204 produces data 212 directly relating to the accelerator rate of change.

The data 212 is stored in the data storage unit 210 which stores data relating to the accelerator rate of change. A processor 214 determines whether or not the rate of change is decreasing at a predetermined rate of change. If the rate of change is decreasing at a predetermined rate of change, the controller 216 sends a signal to the fuel injector 218 to cut the fuel to the engine. In the present embodiment, the predetermined rate of change is any negative value to indicate that the user is ceasing to depress the accelerator pedal.

FIG. 4 illustrates yet another embodiment of the present invention. The system 300 includes a vehicle 302 having a sensor 306 measuring the accelerator pedal position. The sensor 306 measures the pedal position when the driver is gradually releasing the accelerator. The sensor 306 produces data 312 to be stored in the data storage unit 310. The data storage unit 310 stores data relating to the pedal position. The data storage unit 310 inputs the information to a processor 314.

The processor is a computer capable of determining if the pedal position is at a predetermined level. If the pedal position is at the predetermined level, the controller 316 sends a signal to the fuel injector 318 to cut the fuel. In one embodiment, the predetermined level is 0% or 0° of angular displacement of the pedal. In the present embodiment, 0° is a position where the foot of the user is completely off or not depressing the accelerator pedal.

The predetermined level of the present invention may also be a situation where the pedal position is greater than 0° but less than 30°. If the pedal position is greater than 0° but less than 30°, the controller 316 sends a signal to the fuel injector or directly to the engine 320 to cut the fuel.

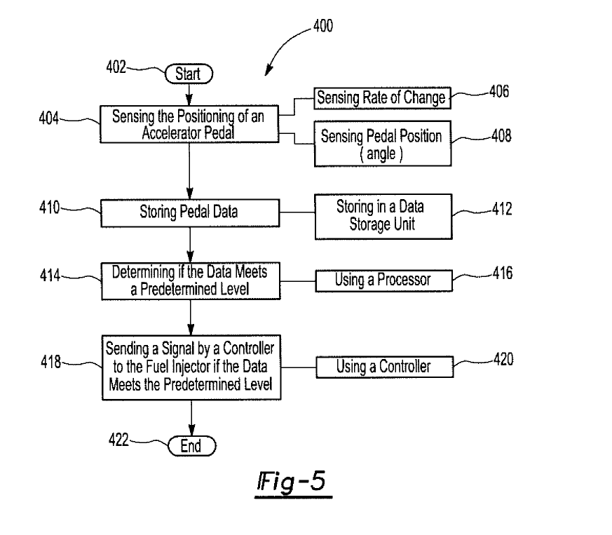

FIG. 5 illustrates a method of the present embodiment to cut the fuel. The method 400 includes the start 402 and then sensing 404 the positioning of an accelerator pedal. The method includes sensing 406 the rate of change and sensing 408 the pedal position (angle). The method 400 further includes storing 410 pedal data relating to the positioning of the accelerator pedal. The method 400 includes storing 412 of the data in a data storage unit. Next, determining 414 if the data meets a predetermined level. The determining 414 if the data meets the predetermined level is determined by using a processor 416. The method 400 then includes the step of sending a signal 418 by a controller to the fuel injector if the data meets the predetermined level. Sending the signal 418 is sent by means of a controller 420. The process then ends 422.

The present invention relates to a decrease in time of activating the fuel cut of between 1 and 2 seconds. This decrease in time increases fuel efficiency of the vehicle.

The present invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. An apparatus for controlling a fuel injector for a vehicle, the apparatus comprising:
a sensor, the sensor measuring positioning of an accelerator pedal, the sensor producing data relating to positioning of the accelerator pedal;
a data storage unit, the data storage unit connected to the sensor, the data storage unit storing the data relating to positioning of the accelerator pedal;
a processor, the processor connected to the data storage unit, the processor to determine if the data relating to the accelerator pedal reaches a predetermined level by comparing the data to the predetermined level, a controller receiving a signal from the processor if the data relating to the accelerator pedal reaches the predetermined level, the controller connected to the processor; and
a fuel injector, the fuel injector in communication with the controller, the controller requiring a fuel cut of the fuel injector if the processor determines that the data relating to the accelerator pedal reaches the predetermined level.

2. The apparatus of claim 1 wherein the sensor measures an accelerator pedal position.

3. The apparatus of claim 1 wherein the sensor measures a rate of change of the accelerator pedal.

4. The apparatus of claim 1 wherein the sensor measures both an accelerator pedal position and a rate of change of the accelerator pedal.

5. The apparatus of claim 1 wherein the data storage unit is a computer.

6. The apparatus of claim I wherein the processor is a computer.

7. The apparatus of claim 3 wherein the predetermined level is between 0%-30% rate of change.

8. The apparatus of claim 2 wherein the predetermined level is 0°-30° angle displacement.

9. The apparatus of claim 4 wherein the predetermined levels are 0%-30% rate of change and 0°-30° angle displacement.

10. A method for controlling fuel flow from a fuel injector of a vehicle, the method comprising the steps of:
sensing by an accelerator pedal sensor, the sensor sensing the positioning of an accelerator pedal;
storing data relating to the positioning of the accelerator pedal in a data storage unit;
determining by a processor if the data relating to the positioning of the accelerator pedal is above a predetermined level by comparing the data to the predetermined level;
sending a signal by a controller to the fuel injector to stop fuel flow if the data relating to the positioning of the accelerator pedal is above the predetermined level.

11. The method of claim 10 wherein the sensor measures an accelerator pedal position.

12. The method of claim 10 wherein the sensor measures a rate of change of the accelerator pedal.

13. The method of claim 10 wherein the sensor measures both an accelerator pedal position and a rate of change of the accelerator pedal.

14. The method of claim 10 wherein the data storage unit is a computer.

15. The method of claim 10 wherein the processor is a computer.

16. The apparatus of claim 12 wherein the predetermined level is between 0%-30% rate of change.

17. The apparatus of claim 11 wherein the predetermined level is 0° -30° angle displacement.

18. The apparatus of claim 13 wherein the predetermined levels are 0%-30% rate of change and 0°-30° angle displacement.
